(19) United States
(12) Patent Application Publication
(10) Pub. No.: US 2015/0145751 A1
(43) Pub. Date: May 28, 2015

(54) IMAGE DISPLAY APPARATUS AND IMAGE DISPLAY METHOD

(71) Applicant: KABUSHIKI KAISHA TOSHIBA, Tokyo (JP)

(72) Inventor: Yoshiharu MOMONOI, Kanagawa-ken (JP)

(73) Assignee: KABUSHIKI KAISHA TOSHIBA, Tokyo (JP)

(21) Appl. No.: 14/209,226

(22) Filed: Mar. 13, 2014

Related U.S. Application Data
(60) Provisional application No. 61/908,860, filed on Nov. 26, 2013.

(51) Int. Cl. G02B 27/01; G06F 3/01; G06F 3/00; G02B 27/00

(52) U.S. Cl. CPC G02B 27/0172; G02B 27/0093; G02B 27/0101; G06F 3/013; G06F 3/005; G02B 2027/0138
USPC 345/8; 359/619; 349/11; 362/97.2

(57) ABSTRACT

According to one embodiment, an image display apparatus includes a light source array, a lens array, a transmission type display and a field lens. The light source array has a plurality of point light sources. The lens array is facing the light source array, and having a plurality of lenses, each of which corresponds to a first number of the point light sources. The transmission type display is facing the lens array and configured to display an image by light beams from the point light sources. The field lens is facing the transmission type display and configured to output light beams from the transmission type display in a first direction.

### CROSS-REFERENCE TO RELATED APPLICATIONS

This application is based upon and claims the benefit of U.S. provisional Application No. 61/908,860, filed on Nov. 26, 2013; the entire contents of which are incorporated herein by reference.

### FIELD

An embodiment of the present invention relates to an image display apparatus and an image display method.

### BACKGROUND

A display technique called head mounted display is known. The head mounted display is worn on a face like glasses. Therefore, an image display device like the head mounted display is required to provide an image offering a feeling of immersion without imposing a burden on eyes of a user.

### BRIEF DESCRIPTION OF THE DRAWINGS

FIG. 1 is a schematic diagram of an image display apparatus 100 according to an embodiment.

FIG. 2 is an exploded perspective view of the image display apparatus 100 according to the embodiment.

FIG. 3 is a diagram showing a condition in which a user can correctly observe an image.

FIG. 4 is a diagram showing a condition in which a user can correctly observe an image.

FIG. 5 is a diagram for explaining design of the image display apparatus 100.

FIG. 6 is a diagram for explaining an operation in a case in which a pupil moves toward the lower side of the page.

FIG. 7 is a diagram schematically showing an image formed in the pupil.

FIG. 8 is a diagram showing a specific example of a configuration of the image display apparatus 100.

FIG. 9 is a diagram showing another specific example of the configuration of the image display apparatus 100.

FIG. 10 is a diagram showing further another specific example of the configuration of the image display apparatus 100.

FIG. 11 is a schematic diagram of an image display apparatus including a forward image pickup camera 7.

### DETAILED DESCRIPTION

According to one embodiment, an image display apparatus includes a light source array, a lens array, a transmission type display and a field lens. The light source array has a plurality of point light sources. The lens array is facing the light source array, and having a plurality of lenses, each of which corresponds to a first number of the point light sources. The transmission type display is facing the lens array and configured to display an image by light beams from the point light sources. The field lens is facing the transmission type display and configured to output light beams from the transmission type display in a first direction.

Hereinafter, an embodiment will be specifically described with reference to the drawings.

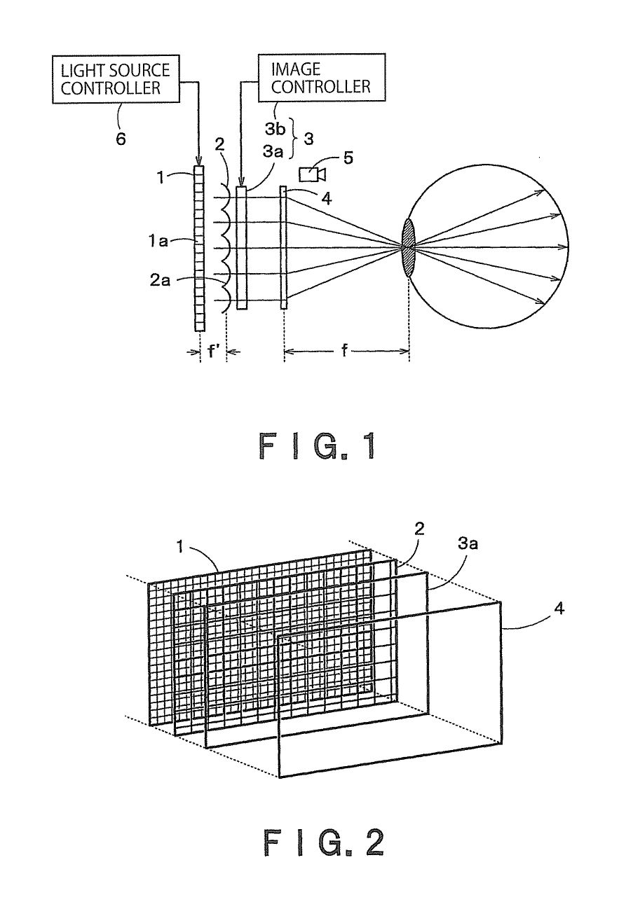

FIG. 1 is a schematic diagram of an image display apparatus 100 according to the embodiment. FIG. 2 is an exploded perspective view of main part of the image display apparatus 100. The image display apparatus 100 can be used as a head mounted display and can be worn on a face of a user like glasses. The image display apparatus 100 includes a light source array 1, a lens array 2, a display module 3, a field lens 4, a camera (a second camera) 5, and a light source controller 6.

The light source array 1 includes a plurality of point light sources 1a. Each of the point light sources 1a is independently on/off-controlled by the light source controller 6 described below.

The lens array 2 is provided facing the light source array 1 on the side closer to an eye of a user. The distance between the light source array 1 and the lens array 2 is substantially equal to a focal length f′ of the lens 2a. The array 2 includes a plurality of lenses 2a. A predetermined number (for example three in the horizontal direction×three in the vertical direction) of point light sources 1a correspond to one lens 2a. In other words, the predetermined number of point light sources 1a is arranged behind one lens 2a.

The display module 3 includes a transmission type display 3a and an image controller 3b. The transmission type display 3a is provided facing the lens array 2 on the side closer to the eye of the user. The transmission type display 3a displays an image by light beams from the light source array 1. The displayed image is controlled by the image controller 3b. As an example, the transmission type display 3a is a liquid crystal display and the image controller 3b adjusts deflection of the liquid crystal according to a video signal supplied from outside. Thereby, transmission/non-transmission of the light from the light source array 1 is controlled and a desired image is displayed.

The field lens 4 is provided facing the display module 3 on the side closer to the eye of the user. The field lens 4 outputs light beams emitted from the transmission type display 3a in a specific direction, that is, toward a pupil of the user. The distance between the field lens 4 and the eye (more specifically, the pupil) of the user is substantially equal to a focal length f of the field lens 4.

The camera 5 is provided at any position and picks up an image of the eye of the user.

The light source controller 6 detects the pupil from the image picked up by the camera 5. The light source controller 6 electronically on/off-controls each of the point light sources 1a on the basis of the position of the detected pupil.

An overview of the operation of the image display apparatus 100 is as follows. The light beams from the point light sources 1a enter the lens array 2. The light beams illuminate the transmission type display 3a from behind, and an image is displayed on the transmission type display 3a. The light beams from the transmission type display 3a enter the field lens 4. Here, the distance between the field lens 4 and the eye of the user is substantially equal to the focal length f of the field lens 4. Therefore, the light beams from the transmission type display 3a are collected by the field lens 4 and pass through part of the pupil.

That is, the light beams from the transmission type display 3a are collected by the field lens 4, pass through only part of the pupil, and reach a retina. A state in which the aperture of the pupil is reduced (the pupil is closed) can obtained, and thus the depth of field is deepened, thereby suppressing effects of image formation by the crystalline lens of the user. Therefore, the image display apparatus 100 is difficult to be affected by abnormal image formation such as short-sightedness, far-sightedness, and far-sightedness due to old age, and the image display apparatus 100 can provide an image of high sharpness to any user.

Moreover, the distance between the light source array 1 and the lens array 2 is substantially equal to the focal length f′ of the lens 2a. Therefore, the light beams from the point light sources 1a become quasi-parallel light beams. The quasi-parallel light beams from the point light sources 1a pass through the lens 2a and enter the transmission type display 3a at the same angle in the entire screen. When the center of the light source array 1 is on an optical axis of the lens array 2, the light from the center of the light source array is vertically emitted to the transmission type display 3a. When the light beam from the transmission type display 3a is in a condition same as the above, the light beam from the transmission type display 3a vertically enters the field lens 4. Therefore, even if the optical axis of the light beam from each point light source 1a is somewhat shifted, the light beam substantially vertically enters the transmission type display 3a and the field lens 4, so that it is possible to suppress degradation of image due to diagonal incident light to the transmission type display 3a and the field lens 4. Similarly, from the characteristics of evenly irradiating the entire surface with substantially vertical quasi-parallel light beams, it is possible to suppress luminance unevenness around the image regardless of the angular characteristics of the point light sources 1a and the lens array 2 or the view angle of the transmission type display 3a.

Further, a virtual image of the transmission type display 3a is generated by the field lens 4 at a position farther away from the eye of the user than a position where the transmission type display 3a is actually located. Thereby, even when the depth of field is not sufficient, the image surface is away from the eye, so that it is possible to reduce the burden on the eye of the user. The virtual image is enlarged by the field lens 4, and the virtual image is larger than the actual transmission type display 3a. Therefore, it is possible to provide an image with a wide angle of view to the user by using the small-sized image display apparatus 100.

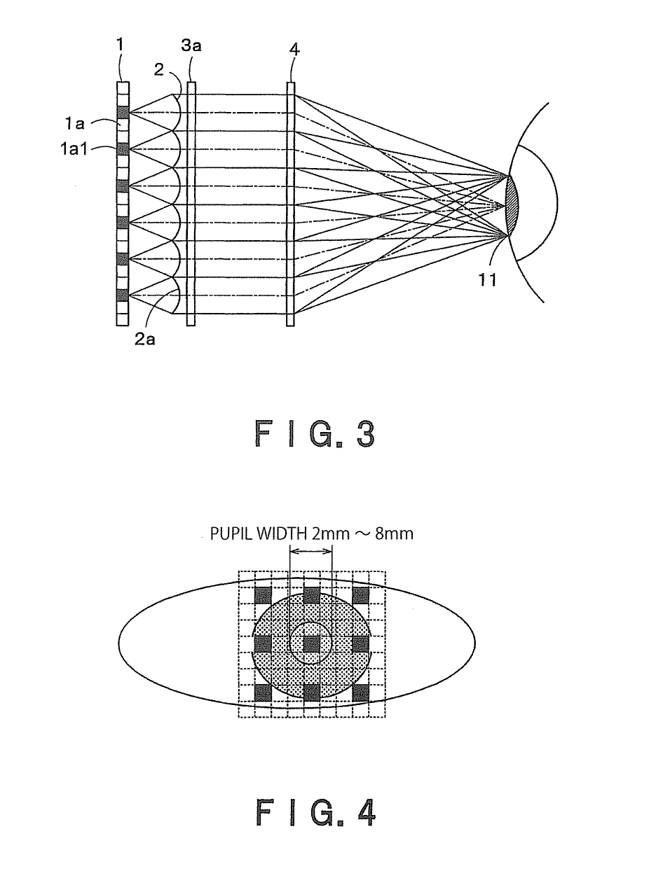

Next, the embodiment will be described in further detail. FIGS. 3 and 4 are diagrams showing a condition in which a user can correctly observe an image. As shown in FIG. 3, the light beams from the transmission type display 3a, which are collected by the field lens 4, enter part of the pupil.

Here, the lens array 2 including a plurality of lenses 2a is used, so that light is periodically and repeatedly collected by the light beams from the lenses 2a adjacent to each other. As a result, an image is periodically and repeatedly formed. At this time, as shown in FIG. 4, if only one image enters the pupil, the user can correctly observe the image. However, if a plurality of images enter the pupil, the user observes an abnormal image as a double image.

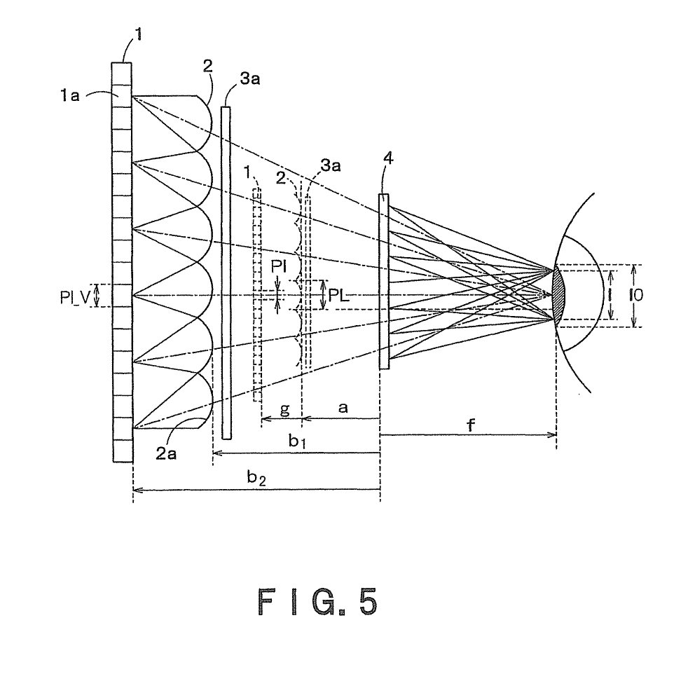

Design of the image display apparatus 100, where only one image enters the pupil, that is to say, the image can be correctly observed, will be described. As shown in FIG. 5, virtual images of the transmission type display 3a, the lens array 2, and the light source array 1 are formed by the field lens 4. In FIG. 5, the virtual images are drawn by solid lines and the real things are drawn by dashed lines. In the description below, the formed virtual images are used.

Parameters are defined as follows:
Focal length of the field lens 4: f
Position of the lens array 2: a
Position of the light source array 1: a+g
Position of the virtual image of the lens array 2: b1
Position of the virtual image of the light source array 1: b2
Pitch of the lens 2a: PL
Pitch of the point light source 1a: PI
Pitch of the point light source 1a in the virtual image: PI_V
Magnification of the lens array 2 in the virtual image: m1
Magnification of the light source array 1: m2
The number of the point light sources 1a corresponding to one lens in the horizontal direction and in the vertical direction: n
Width (height) of the formed image: I
Width of the pupil: I0 (typically, 8 mm at the maximum) Here, the position of the field lens 4 is defined as the origin, and the pupil side of the user is defined as positive. Thus, the position a of the lens array 2 or the like has a negative value.

Regarding the position b1 of the virtual image of the lens array 2 formed by the field lens 4, the following formula (1) is established from a lens formula.

1/b1−1/a=1/f (1)

Thus, the position b1 of the virtual image of the lens array 2 is represented by the following formula (2):

b1=(f*a)/(f+a) (2)

Similarly, the position b2 of the virtual image of the light source array 1 is represented by the following formula (3):

b2={f*(a+g)}/(f+a+g) (3)

The magnification m2 of the light source array is represented by the formula (4) from a similarity relation.

m2=b2/(a+g) (4)

The pitch PI_V of the point light source 1a in the virtual image is represented by the following formula (5) by using the magnification m2 of the formula (4).

PI_{—}V=m2*PI (5)

On the other hand, the magnification m1 of the lens array 2 in the virtual image is represented by the formula (6) from a similarity relation.

m1=(|b1|+f)/(|b2|−|b1|) (6)

The width (height) I of the image formed by the collected light beams is represented by the following formula (7) by using the magnification m1 of the formula (6).

I=m1*PI_{—}V (7)

The formula (8) is established from the formulas (5) to (7) described above.

I=(|b1|+f)/(|b2|−|b1|)*m2*PI (8)

Note that, from the formulas (2) to (4), b1, b2, and m2 are values represented by using a, g, and f.

Here, n point light sources 1a correspond to one lens 2a, and there are n point light sources 1a behind one lens 2a. The image formed by the collected light beams is repeatedly formed for each lens pitch PL. Thus, the width (period) Ip of repetition of the formed image is obtained by multiplying the number n of the point light sources 1a behind the lens 2a and the width I of the image, so that the width (period) Ip is represented by the following formula (9):

Ip=n*I (10)

If the period Ip of repetition is smaller than the width I0 of the pupil, the image is doubly observed. Therefore, it is necessary to satisfy the following formula (11).

Ip=n*I>I0 (11)

Moreover, to make the light beams from the light source array 1 and the lens array 2 to be quasi-parallel light beams, the pitch PL of the lens 2a has to be a product of the pitch PI of the point light source 1a and the number n of the point light sources 1a behind the lens 2a. Thus, the formula (12) is established.

PL=PI*n (12)

From the above, the formula (13) is established.

n<int(I0/I)=PL/PI

PL=PI*int(I0/I) (13)

Here, int(x) means that the fractional part of x is omitted. The pitch PL of the lens 2a, the pitch PI of the point light source 1a, the position a of the transmission type display 3a, the position g of the light source array 1, and the focal length f may be designed so as to satisfy the relation of the formula (13).

At this time, it is possible to obtain an effect to deepen the depth of field by reducing the width I of the image. Hereinafter, an example of a method of deriving the depth of field of an eye will be described. It is desirable to design the width I (pitch PI_V) of the image based on the deriving method.

In a model eye which is used as a simple model of an eye, the focal length is defined to be, for example, 17 mm. When a distance between a main point distance of the eye and a retina is 17 mm and a visual angle one minute differential threshold which is a basis of the eyesight of 1.0 is used as a basis, a diameter δ which is a basis of a least confusion circle can be obtained by the formula (14) below. However, in practice, pixels of the transmission type display 3a to be used are coarser than the diameter δ, so that condition can be loosened based on the pixels.

δ=17 mm×tan( 1/60)=0.005 mm (14)

For example, the depth of field is obtained on the basis of a vision length (250 mm). It is known that the depth of field is given by the formulas (15) and (16) below.

Front depth of field=s²×δ×F/(f²+s×δ×F) (15)

Back depth of field=s²×δ×F/(f²−s×δ×F) (16)

Here, F is the f-number f/D (f is the focal length=17 mm, D is the width of the aperture=the width I of the image).

When the calculation is performed by using s which is a distance of the depth of field (=250 mm), if the width I of the aperture is 4 mm, the depth of field (that is, the sum of the front depth of field and the back depth of field) is about 8 mm. On the other hand, if the width I of the aperture is 0.2 mm, the depth of field can be increased to about 200 mm.

In this way, it is possible to increase the depth of field by setting the width I of the image to a diameter of about 0.1 to 2 mm and reduce the burden on the eye. For example, if setting the width I of the image to 0.8 mm on the basis of 8 mm, the number n of the point light sources 1a is 10, so that 100 point light sources correspond to one lens in the horizontal and vertical directions.

The position of the pupil may move. Therefore, it is desirable to selectively cause the point light sources 1a to emit light according to the position of the pupil. For this purpose, for example, it is considered to provide a camera 5 to pick up an image of the eye of the user. The light source controller 6 detects the position of the pupil from the image picked up by the camera 5. Further, the light source controller 6 turns on (lights) one of the n point light sources 1a1 corresponding to each lens 2a and turns off (unlights) the other point light sources 1a. Thereby, only one image formed by the field lens 4 enters the pupil of the user.

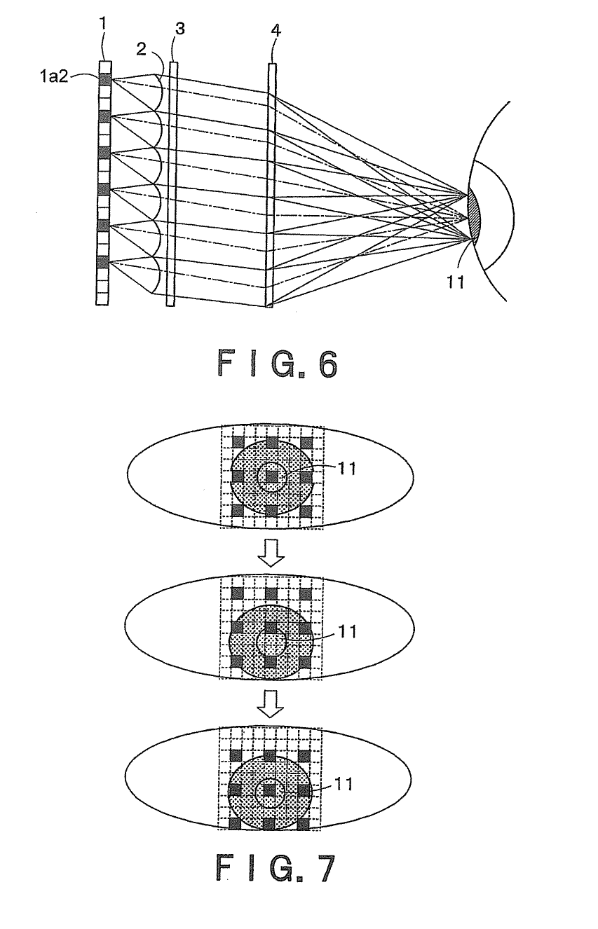

For example, as shown in FIGS. 3 and 4, when the pupil is located at the center, the light source controller 6 turns on only one point light source 1a behind the center of each lens 2a. On the other hand, as shown in FIG. 6, when the pupil moves downward in the page, the light source controller 6 turns on one point light source 1a2 behind an upper portion of each lens 2a in the page. Thereby, as shown FIG. 7, the image is formed at substantially the center of the pupil. In this way, the movement of the position of the pupil is followed, so that two light beams do not enter at the same time. Thus, it is possible to avoid a double image.

Next, some specific configuration examples of the image display apparatus 100 will be described.

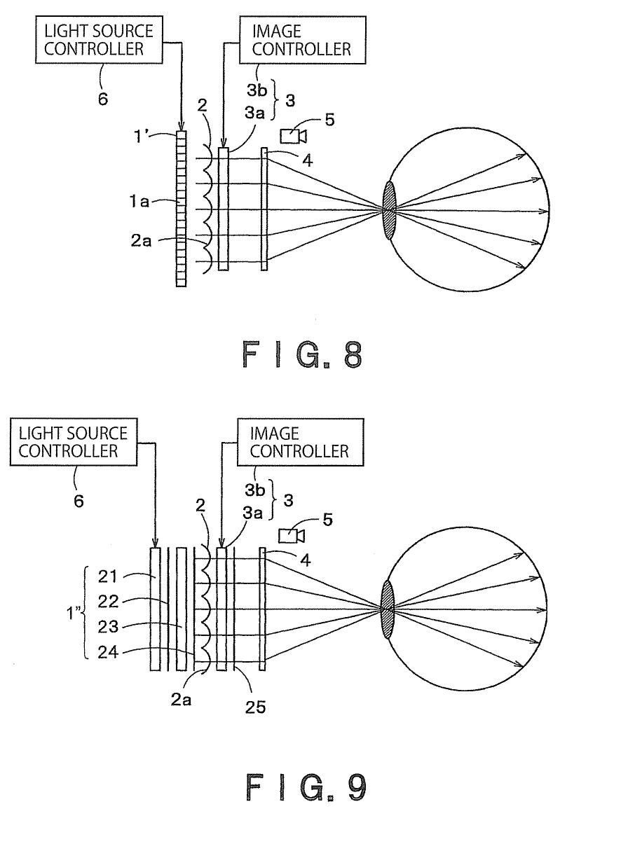

FIG. 8 is a diagram showing a specific example of a configuration of the image display apparatus 100. As shown in FIG. 8, the image display apparatus 100 includes a spontaneous light emitting array element as the light source array 1. The spontaneous light emitting array element is an organic EL light emitting element, a plasma display, an LED array, or the like. To reduce the size of the image display apparatus 100, it is necessary to reduce the pitch of the point light sources 1a in the light source array 1. For this purpose, it is desirable that the spontaneous light emitting array element can be a high definition element.

FIG. 9 is a diagram showing another specific example of a configuration of the image display apparatus 100. As shown in FIG. 9, the image display apparatus 100 includes, as a light source array 1″, a backlight device 21 a polarizing plate 22 facing the backlight device 21, a liquid crystal display 23 facing the polarizing plate 22, and a polarizing plate 24 facing the liquid crystal display 23.

The liquid crystal display 23 may be the same as the transmission type display 3a. The liquid crystal display 23 includes, for example, a Twisted Nematic (TN) liquid crystal. In this case, it is possible to switch between a polarization state in which phase is shifted by 90 degrees and a polarization state in which phase is not shifted according to a voltage applied to the liquid crystal. It is possible to control transmission/non-transmission of light beams by causing the light beams to pass through the polarizing plate 24 in the polarization state in which phase is shifted by 90 degrees.

Only light of a specific polarization direction among light emitted from the backlight device 21 passes through the polarizing plate 22. Part of the light from the backlight device 21 is passed through and the other light is blocked by appropriately applying a voltage to the TN liquid crystal of the liquid crystal display and causing the light to pass through the polarizing plate 24. Thereby, the point light source 1a can be realized.

The polarization directions of the light beams that illuminate the transmission type display 3a for displaying an image are aligned by the polarizing plate 24, so that a rear polarizing plate is not required. Depending on the polarization state of light entering the rear surface of the transmission type display 3a for displaying an image, it is considered to provide a polarizing plate 25 as needed which faces the transmission type display 3a and which shifts the phase of the polarization direction by 90 degrees.

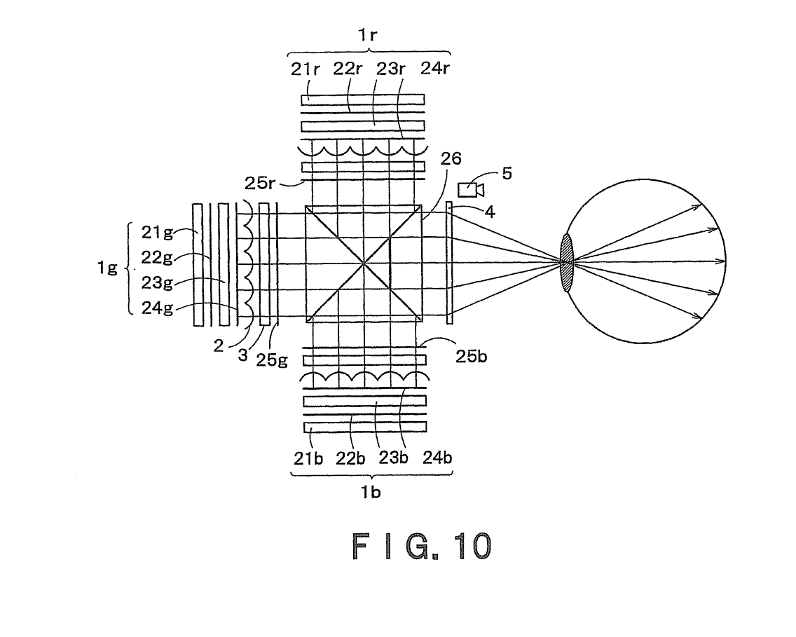

FIG. 10 is a diagram showing further another specific example of a configuration of the image display apparatus 100 (In FIG. 10, the image controller 3b and the light source controller 6 are not shown). The image display apparatus 100 includes three light source arrays 1r, 1g, and 1b and a dichroic prism (an optical coupler) 26. Each of the light source arrays 1r, 1g, and 1b is the light source array 1″ shown in FIG. 9. Colors (wavelengths) of the light beams emitted from backlight devices 21r, 21g, and 21b are different from each other. For example, light beams of each of the three primary colors, that is, red, green, and blue, are emitted from the backlight devices 21r, 21g, and 21b, respectively. The dichroic prism 26 couples the light beams from the backlight devices 21r, 21g, and 21b, generates a color image, and orients the light beams to the field lens 4.

As compared with a method in which the three primary colors are separated by using color filters, it is possible to improve utilization efficiency of light by separating colors of the light source in advance.

The efficiency of the dichroic prism 26 depends on the incident angle of the light beams. In the present embodiment, the lens array 2 is provided, so that the light beams substantially vertically enter the dichroic prism 26. Therefore, even in an area around the image, the incident angle of the light is substantially constant, so that it is possible to prevent luminance efficiency from decreasing.

As described above, in the present embodiment, the lens array 2 is arranged facing the light source array 1. Therefore, the light beams that pass through the lens array 2 substantially vertically enter the transmission type display 3a. Thus, it is possible to provide a high quality image to the user. Further, the field lens 4 is arranged facing the eye of the user. Therefore, a large virtual image is formed at a position farther away from the eye than the actual transmission type display 3a. Thus, it is possible to reduce the size of the image display apparatus 100, and further it is possible to provide a large image offering a feeling of immersion without imposing a burden on the eye of the user because the image surface is away from the eye even when the depth of field is not sufficient.

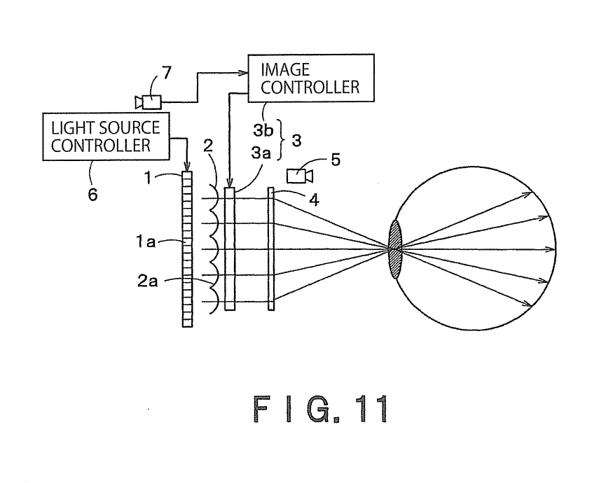

As shown in FIG. 11, it is possible to further provide a forward image pickup camera (a first camera) 7 that picks up an image in front of the user. The image controller 3b may display the image picked up by the forward image pickup camera 7 on the transmission type display 3a. Thereby, the image display apparatus 100 can be used as glasses.

At this time, an image of the eye may be picked up by the camera 5 and an image-pickup direction of the forward image pickup camera 7 may be controlled according to the orientation of the eye. Further, the focal point of the forward image pickup camera 7 may be adjusted according to an angle of convergence detected from eye directions in an image picked up by the camera 5. In other words, it is possible to adjust the focal point of the forward image pickup camera 7 to a position near the intersection point of eye lines on the basis of the angle of convergence. For example, when the angle of convergence is large, the user observes a thing close to the user. Therefore, it is desirable that the forward image pickup camera 7 adjusts the focus and the image pickup direction to a short distance view. On the other hand, when the angle of convergence is small, the user observes a thing far away from the user. Therefore, it is desirable that the forward image pickup camera 7 adjusts the focus and the image pickup direction to a long distance view. When the user observes a long distance view, the image controller 3b may display an enlarged image on the transmission type display 3a.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image display apparatus comprising:
a light source array comprising a plurality of point light sources;
a lens array facing the light source array and comprising a plurality of lenses, each of which corresponds to a first number of the point light sources;
a transmission type display facing the lens array and configured to display an image by light beams from the point light sources; and
a field lens facing the transmission type display and configured to output light beams from the transmission type display in a first direction.

2. The apparatus of claim 1, wherein
the light beams from the point light sources passing through the lens substantially vertically enter the transmission type display, and
the light beams from the transmission type display substantially vertically enter the field lens.

3. The apparatus of claim 1, wherein a distance between the light source array and the lens array is substantially equal to a focal length of the lens.

4. The apparatus of claim 1, wherein
the image display apparatus is a head mounted display that is worn on a face of a user, and
a distance between the field lens and a pupil of the user is substantially equal to a focal length of the field lens.

5. The apparatus of claim 1, wherein
the image display apparatus is a head mounted display that is worn on a face of a user, and
the image display apparatus further comprises:
a camera configured to pick up an image of an eye of the user, and
a light source controller configured to turn on one point light source among the first number of the point light sources corresponding to each lens and turn off the other point light sources so that only one of a plurality of images formed by the field lens enters a pupil of the user on the basis of a position of the pupil detected from the image picked up by the camera.

6. The apparatus of claim 1, wherein
the image display apparatus is a head mounted display that is worn on a face of a user, and
a pitch of the lens, a pitch of the point light source, a position of the transmission type display, a position of the light source array, and a focal length of the field lens are designed so that only one of a plurality of images formed by the field lens enters a pupil of the user.

7. The apparatus of claim 1, wherein the light source array comprises:
a backlight device;
a first polarizing plate facing the backlight device;
a liquid crystal display facing the first polarizing plate; and
a second polarizing plate facing the liquid crystal display.

8. The apparatus of claim 1, comprising:
a plurality of the light source arrays, wavelengths of light beams emitted from the point light sources of each of the light source arrays being different from each other;
a plurality of the lens arrays facing the plurality of light source arrays, respectively;
a plurality of the transmission type displays facing the plurality of lens arrays, respectively; and
an optical coupler configured to couple light beams, which are emitted from the plurality of light source arrays, and pass through the lens arrays and the transmission type displays which are facing the light source arrays, and to orient the coupled light beams to the field lens.

9. The apparatus of claim 1, wherein
the image display apparatus is a head mounted display that is worn on a face of a user, and
the image display apparatus further comprises:
a first camera configured to pick up an image in front of the user; and
an image controller configured to display the image picked up by the first camera on the transmission type display.

10. The apparatus of claim 9 further comprising a second camera configured to pick up an image of an eye of the user,
wherein an image-pickup direction and a focal point of the first camera are set based on an angle of convergence of eyes of the user which is detected from the image picked up by the second camera.

11. An image display method comprising:
emitting light beams from a light source array comprising a plurality of point light sources;
injecting the light beams into a transmission type display through a lens array facing the light source array, the lens array comprising a plurality of lenses, each of which corresponds to a first number of the point light sources;
displaying an image on the transmission type display by the injected light beams; and
outputting light beams from the transmission type display in a first direction.
